(19) United States
(12) Patent Application Publication
(10) Pub. No.: US 2015/0026364 A1
(43) Pub. Date: Jan. 22, 2015

(54) SEMICONDUCTOR DEVICE AND MEMORY SYSTEM HAVING THE SAME

(71) Applicant: SK hynix Inc., Gyeonggi-do (KR)

(72) Inventor: Hyun CHUNG, Seoul (KR)

(73) Assignee: SK hynix Inc., Gyeonggi-do (KR)

(21) Appl. No.: 14/092,659

(22) Filed: Nov. 27, 2013

(30) Foreign Application Priority Data
Jul. 18, 2013 (KR) 10-2013-0084686

(51) Int. Cl. G06F 3/06; G06F 13/40

(52) U.S. Cl. CPC G06F 3/0659; G06F 13/4022; G06F 3/061; G06F 3/0688
USPC 710/5; 710/316; 710/305

(57) ABSTRACT

A semiconductor device includes a plurality of bus lines, a plurality of bus bar lines grouped in pairs with the plurality of bus lines, respectively, and a parameter register including a plurality of parameter groups coupled to the plurality of bus lines and a plurality of bus bar lines, wherein the parameter groups store parameters for different operating modes.

### CROSS-REFERENCE TO RELATED APPLICATION

The present application claims priority of Korean patent application number 10-2013-0084686, filed on Jul. 18, 2013, the entire disclosure of which is incorporated herein by reference in its entirety.

### BACKGROUND

1. Field of Invention

Various embodiments of the present invention relate to a semiconductor device and a memory system having the same and, more particularly, to a semiconductor device including a parameter register and a memory system having the same.

1. Description of Related Art

A semiconductor device may include a memory cell array, peripheral circuits, and a control circuit. The memory cell array may store data. The peripheral circuits may be configured to perform a program operation, a read operation, and an erase operation on the memory cell array. The control circuit may be configured to control the peripheral circuits. A system may include a host and the above-described semiconductor device. The host may transfer a command signal and addresses to the semiconductor device and receive data from the semiconductor device. The semiconductor device may include a parameter register in the control circuit in order to support various modes that suit environment of the host configured to control operating characteristics, such as data input/output speeds and a power level.

Various feature parameters for determining operating characteristics may be stored in the parameter register. Since semiconductor devices support more various operating modes, the number of feature parameters has been increasing. An increase in the number of feature parameters may lead to an increase in time taken to set them. For example, when the power is on, the semiconductor device may input feature parameters in the parameter register. Subsequently, when an operating mode is selected, the semiconductor device may sequentially read the feature parameters stored in the parameter register in search of feature parameters applied to the selected operating mode. Therefore, in line with diversification of operating modes, as capacity of feature parameters input to the parameter register increases, it may take more time to switch the operating modes. As a result, an operating speed of the semiconductor device may be reduced, and the overall performance of the memory system may be degraded.

### BRIEF SUMMARY

Exemplary embodiments of the present invention relate to a parameter register allowing easy management of feature parameters.

Exemplary embodiments of the present invention also relate to a semiconductor device capable of quickly switching operating modes by quickly reading feature parameters.

A semiconductor device according to an exemplary embodiment of the present invention may include a plurality of bus lines, a plurality of bus bar lines grouped in pairs with the plurality of bus lines, respectively, and a parameter register including the plurality of parameter groups coupled to the plurality of bus lines and the plurality of bus bar lines, wherein the parameter groups store parameters for different operating modes

A semiconductor device according to another exemplary embodiment of the present invention may include a memory cell array storing data, a peripheral circuit performing a program operation, a read operation, and an erase operation on the memory cell array, and a control circuit storing parameters for different operating modes in different parameter groups, wherein the control circuit is suitable for controlling the peripheral circuit by outputting parameters stored in a parameter group corresponding to a selected operating mode when operating modes are switched, and causing the semiconductor device to operate in the selected operating mode.

A memory system according to an exemplary embodiment of the present invention may include a host suitable for outputting a command signal and addresses, and a semiconductor device including a control circuit, a peripheral circuit and a memory cell array to perform program, read, and erase operations and exchange data with the host in response to the command signal and the addresses, wherein the control circuit stores parameters for different operating modes in different parameter groups and is suitable for controlling the peripheral circuit by outputting parameters stored in a parameter group corresponding to a selected operating mode when operating modes are switched, and causing the semiconductor device to operate in the selected operating mode.

### BRIEF DESCRIPTION OF THE DRAWINGS

FIG. 1 is a schematic view illustrating a memory system including a semiconductor device according to an embodiment of the present invention;

FIG. 2 is a schematic view illustrating the configuration of a control circuit of a semiconductor device according to an embodiment of the present invention;

FIG. 3 is a circuit view illustrating a parameter register according to an embodiment of the present invention in detail; and

FIG. 4 is a view illustrating a method of switching operating modes of a semiconductor device according to an embodiment of the present invention.

### DESCRIPTION OF EMBODIMENTS

Hereinafter, various embodiments of the present invention will be described in detail with reference to the accompanying drawings. The figures are provided to enable those of ordinary skill in the art to make and use the present invention according to the exemplary embodiments of the present invention. Throughout the disclosure, reference numerals correspond directly to the like numbered parts in the various figures and embodiments of the present invention.

Furthermore, ‘connected/coupled’ represents that one component is directly coupled to another component or indirectly coupled through another component. In this specification, a singular form may include a plural form as long as it is not specifically mentioned in a sentence. Furthermore, ‘include/comprise’ or ‘including/comprising’ used in the specification represents that one or more components, steps, operations, and elements exists or are added.

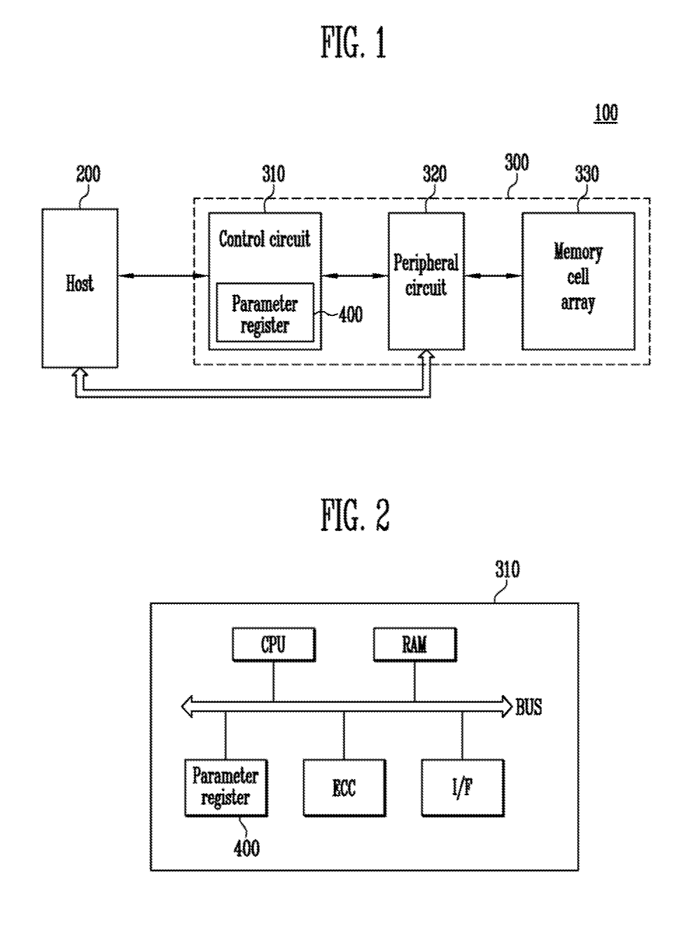

FIG. 1 is a schematic view of a memory system including a semiconductor device according to an embodiment of the present invention.

Referring to FIG. 1, a memory system 100 may include a host 200 and a semiconductor device 300.

The host 200 may output a command signal and an address to control the semiconductor device 300.

The semiconductor device 300 may include a control circuit 310, a peripheral circuit 320 and a memory cell array 330 that are configured to perform program, read, and erase operations and exchange data in response to the command signal and the address, which are output from the host 200.

The control circuit 310 may receive the command signal and the address from the host 200 and control the peripheral circuit 320 in order to perform the program, read, and erase operations. When a power is applied to the semiconductor device 300, the control circuit 310 may store parameters for various operating modes in group units, divided into different operating modes, and control the peripheral circuit 320 so that the semiconductor device 300 may operate in a selected operating mode by outputting parameters of a group corresponding to the selected operating mode when operating modes are switched.

Parameters may be a type of default data for setting various operating modes of the semiconductor device 300 and may refer to data for determining data input/output speeds, a power voltage level and a verify voltage level. Since these parameters determine operating characteristic of the semiconductor device 300, parameters may be referred to as feature parameters. For example, parameters needed for the semiconductor device 300 to operate in a high-voltage mode or parameters needed for the semiconductor device 300 to operate in a low-voltage mode may be stored in the parameter register 400. Since there may be various operating modes of the semiconductor device 300, a plurality of parameters for each of the operating modes may be stored in the parameter register 400.

The peripheral circuit 320 may include a plurality of circuits that may perform program, read, and erase operations on the memory cell array 330 and transfer read data to the host 200 in response to control of the control circuit 310.

The memory cell array 330 may include a plurality of memory blocks (not illustrated). Each of the memory blocks may include a plurality of cell strings (not illustrated). Each of the cell strings may include a plurality of memory cells (not illustrated).

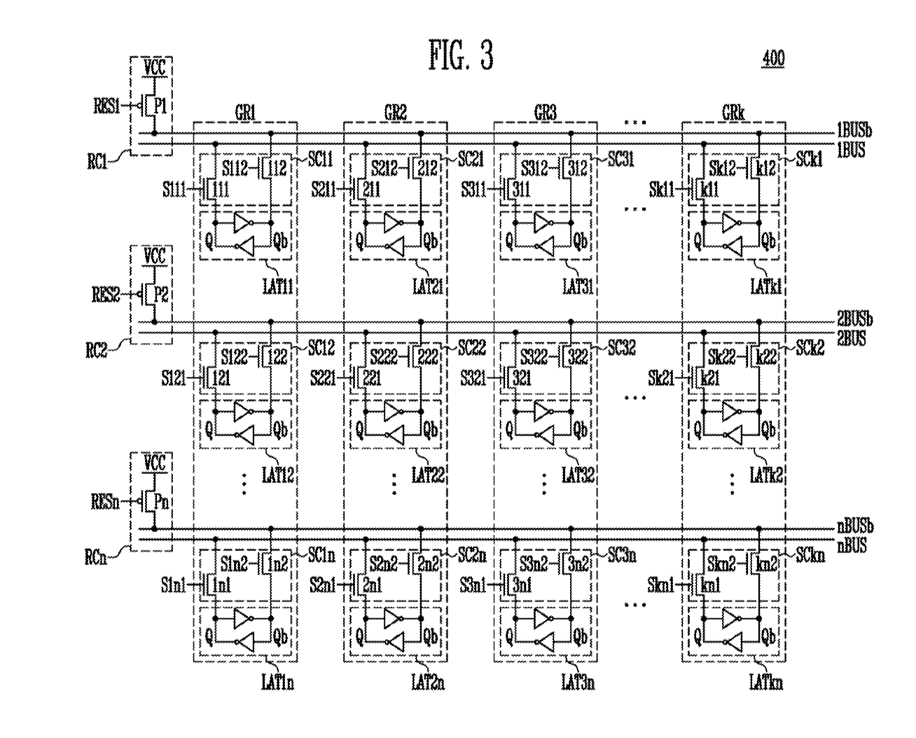

FIG. 2 is a schematic view of the configuration of a control circuit of a semiconductor device according to an embodiment of the present invention.

Referring to FIG. 2, the control circuit 310 may include a processing unit CPU, random-access memory RAM, a host interface I/F, an error correcting circuit ECC and the parameter register 400. The processing unit CPU may control the general operation of the semiconductor device 300. The RAM may function as an operation memory of the processing unit CPU. The host interface I/F may include a data exchange protocol between the host 200 of FIG. 1 and the control circuit 310. The error correcting circuit ECC may output an error correcting code when errors occur, and correct the errors. The parameter register 400 may store the parameters for various operating modes.

In addition, though not illustrated in FIG. 2, the control circuit 310 may further include a ROM device that may store code data for interfacing with the host 200.

The memory system 100 may be realized as a portable data storage card of a solid state disk (SSD) that replaces a hard disk of a computer system.

The parameter register 400 of the control circuit 3 0 is described below in detail.

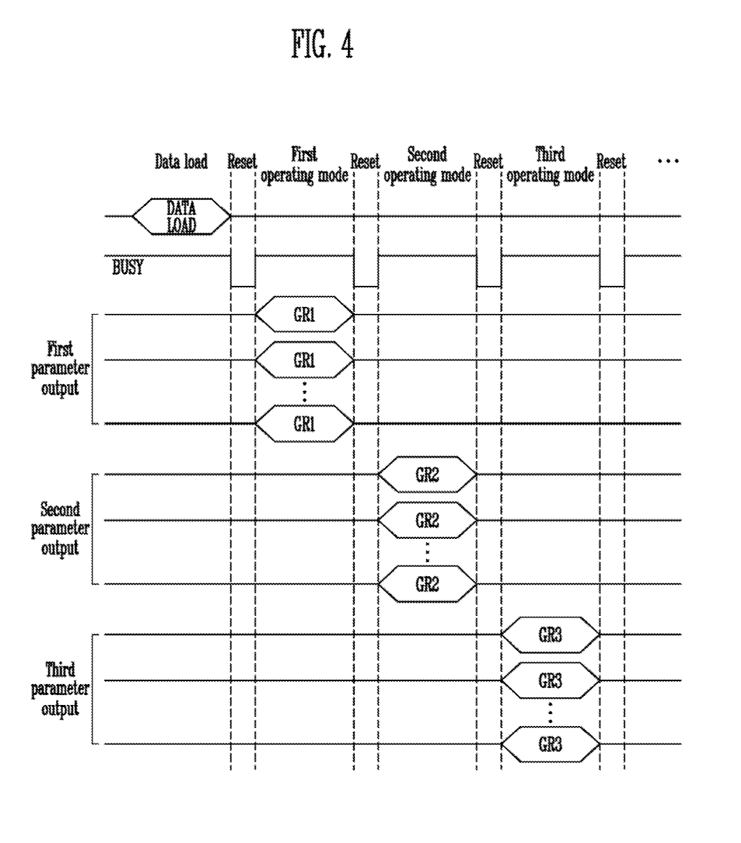

FIG. 3 is a circuit view of a parameter register according to an embodiment of the present invention in detail.

Referring to FIG. 3, the parameter register 400 may include first to k-th parameter groups GR1 to GRk (where k is a positive integer), first to n-th bus lines 1BUS to nBUS and first to n-th reset circuits RC1 to RCn (where n is a positive integer). The first to k-th parameter groups GR1 to GRk may store the parameters which correspond to default values for various operating modes. The first to n-th bus lines 1BUS to nBUS may be used to transfer the parameters. The first to n-th reset circuits RC1 to RCn may be configured to reset the first to n-th bus bar lines 1BUSb to nBUSb and the parameter register 400.

Each of the first to k-th parameter groups GR1 to GRk may include latches and switching units. For example, each of the latches LAT11 to LAT1n, LAT21 to LAT2n, LAT31 to LAT3n and LATk1 to LATkn may be coupled to the first to n-th bus lines 1BUS to nBUS and the first to n-th bus bar lines 1BUSb to nBUSb. For example, the switching units SC11 to SC1n SC21 to SC2n, SC31 to SC3n and SCk1 to SCkn may transfer data, stored in the latches LAT11 to LAT1n, LAT21 to LAT2n, LAT31 to LAT3n and LATk1 to LATkn, to the first to n-th bus lines 1BUS to nBUS or the first to n-th bus bar lines 1BUSb to nBUSb or to another parameter group. The first to k-th parameter groups GR1 to GRk may have substantially the same configuration and be coupled in common to the first to n-th bus lines 1BUS to nBUS and the first to n-th bus bar lines 1BUSb to nBUSb. Thus, the configuration of the first parameter group GR1 is described below in detail.

The first parameter group GR1 may include the first to n-th switching units SC11 to SC1n and the first to n-th latches LAT11 to LAT1n that are grouped in pairs. For example, the first switching unit SC11 and the first latch LAT11 may form a pair, and the n-th switching unit SC1n and the n-th latch LAT1n may form a pair. Pairs of the switching units and the latches, included in the first parameter group GR1, may be coupled to the first to n-th bus lines 1BUS to nBUS and the first to n-th bus bar lines 1BUSb to nBUSb and may be reset by the first to n-th reset circuits RC1 to RCn.

The first switching unit SC11 may include a first switch 111 and a second switch 112. The first switch 111 and the second switch 112 may be coupled between the first bus line 1BUS and the first bus bar fine 1BUSb, and the first latch LAT11. In addition, the first switch 111 and the second switch 112 may operate in response to a first switching signal S111 and a second switching signal S112, respectively. More specifically, the first switch 111 may couple a first node Q of the first latch LAT11 and the first bus line 1BUS to each other in response to the first switching signal S111. The second switch 112 may couple a second node Qb of the first latch LAT11 and the first bus bar line 1BUSb to each other in response to the second switching signal S112. The first and second switches 111 and 112 may include NMOS transistors.

The first latch LAT11 may include two inverters. The first latch LAT11 may store data, transferred from the first bus line 1BUS or the first bus bar line 1BUSb, or transfer the data, stored in the latch, to the first bus line 1BUS or the first bus bar line 1BUSb by operations of the first switch 111 or the second switch 112.

At least one first reset circuit RC1, which may reset the first latch LAT11, may be coupled to the first bus bar line 1BUSb. The first reset circuit RC1 may include a first reset switch P1, which may apply a power voltage VCC to the first bus ba line 1BUSb, in response to a first reset signal RES1. The first reset switch P1 may include a PMOS transistor. For example, when the first reset signal RES1 and the second switching signal S112 are high, data of ‘1’ may be stored in the second node Qb of the first latch LAT11, and data of ‘0’ may be stored in the first node Q thereof, so that the first latch LAT1 1 may be reset. In another example, when only the first reset signal RES1 goes high, only the first bus bar line 1BUSb may be reset. FIG. 3 illustrates the first reset circuit RC1 coupled to the first bus bar line 1BUSb. Depending on the semiconductor device 300, the first latch LAT11 may be reset by coupling the first reset circuit RC1 to the first bus line 1BUS. The first reset circuit RC1 may be coupled to a ground voltage terminal instead of a power voltage VCC terminal. In addition, a time taken to perform a reset operation may be shortened by coupling a plurality of first reset circuits RC1 to the first bus line 1BUS or the first bus bar line 1BUSb.

The second switching unit SC12 and the second latch LAT12 of the first parameter group GR1 may be coupled to the second bus line 2BUS and the second bus bar line 2BUSb. The second reset circuit RC2 may be coupled to the second bus bar line 2BUSb.

In this manner, the n-th switching unit SC1n and the n-th latch LAT1n may be coupled to the n-th bus line nBUS and the n-th bus bar line nBUSb and the n-th reset circuit RCn may be coupled to the n-th bus bar line BUSb.

The second to k-th parameter groups GR2 to GRk may be configured in substantially the same manner as the first parameter group GR1 as described above. For example, the first switching units SC11 to SCk1 included in the first to k-th parameter groups GR1 to GRk may be coupled in common to the first bus line 1BUS and the first bus bar line 1BUSb. The first latches LAT11 to LATk1 included in the first to k-th parameter groups GR1 to GRk, respectively, may be coupled to the first switching units SC11 to SCk1. In other words, since the first to n-th bus lines 1BUS to nBUS and the first to n-th bus bar lines 1BUSb to nBUSb are grouped in pairs, the first switching units SC11 to SCk1 and the first latches LAT11 to LATk1 included in the first to k-th parameter groups GR1 to GRk may be coupled in common to the first bus line 1BUS and the first bus bar line 1BUSb. The second switching units SC12 to SCk2 and the second latches LAT12 to LATk2 may be coupled in common to the second bus line 2BUS and the second bus bar line 2BUSb. The n-th switching units SC1n to SCkn and the n-th latches LAT1n to LATkn may be coupled in common to the n-th bus line nBUS and the n-th bus bar line nBUSb.

In addition, the first and second switches 111 to kn1 and 112 to kn2 included in the first to k-th switching units SC11 to SCkn may operate in response to different switching signals S111 to Skn1 and S112 to Skn2, respectively. The switching signals S111 to Skn1 and S112 to Skn2 and the first to n-th reset signals RES1 to RESn may be output from the control circuit 310 in response to control of the host 200 of FIG. 1.

As described above, since the parameter register 400 may operate in response to different switching signals S111 to Skn1 and S112 to Skn2 and different reset signals RES1 to RESn, the parameters to be stored in the latches LAT11 to LATkn may be managed using various methods.

FIG. 4 is a view illustrating a method of switching operating modes of a semiconductor device according to an embodiment of the present invention.

Referring to FIG. 4, when the power is applied to the semiconductor device 300, the control circuit 310 of FIG. 1 may activate the first to n-th reset signals RES1 to RESn and the second switching signals S112 to Sk12, S122 to Sk22 and S1n2 to Skn2 and reset all the latches LAT11 to LATkn included in the first to k-th parameter groups GR1 to GRk. Subsequently, the control circuit 310 may load parameters, which correspond to data for various operating modes of the semiconductor device, onto the parameter register 400. For example, parameters for a first operating mode may be stored in the first parameter group GR1, parameters for a second operating mode may be stored in the second parameter group GR2, and parameters for a k-th operating mode may be stored in the k-th parameter group GRk. Therefore, all parameters for various operating modes of the semiconductor device 300 may be loaded onto the parameter groups.

When the first operating mode is selected, after the first to n-th bus bar lines 1BUSb to nBUSb are reset, the first parameters, stored in the first parameter group GR1, may be transferred to an internal circuit through the first to n-th bus lines 1BUS to nBUS or the first to n-th bus bar lines 1BUSb to nBUSb. The internal circuit may set the first operating mode in response to the first parameters. When the first operating mode is switched to the second operating mode, after the first to n-th bus bar lines 1BUSb to nBUSb are reset, the first parameters, stored in the first parameter group GR1, may be transferred to the internal circuit through the first to n-th bus lines 1BUS to nBUS or the first to n-th bus bar lines 1BUSb to nBUSb, to thereby set the second operating mode. When the second operating mode is switched to the third operating mode, after the first to n-th bus bar lines 1BUSb to nBUSb are reset, the first parameters stored in the first parameter group GR1 may be transferred to the internal circuit through the first to n-th bus lines 1BUS to nBUS or the first to n-th bus bar lines 1BUSb to nBUSb, to thereby set the third operating mode.

As described above, when operating modes are switched, since parameters corresponding to a selected operating mode may be immediately output, switching and setting operations of operating modes may be quickly performed,

In addition, the parameter register may perform a data exchange operation between the parameter groups in response to the operations of the first to n-th switching units SC11 to SCkn. For example, after the third parameter group GR3 is reset, the parameters stored in the first parameter group GR1 may be transferred to the third parameter group GR3 through the first to n-th bus lines 1BUS to nBUS and the first to n-th bus bar lines 1BUSb to nBUSb.

According to the present invention, since it may be easy to control feature parameters, and operating modes of a semiconductor device may be quickly switched by reducing a read time of the feature parameters. Therefore, performance of a memory system including the semiconductor device may be improved.

What is claimed is:

1. A semiconductor device, comprising:
a plurality of bus lines;
a plurality of bus bar lines grouped in pairs with the plurality of bus lines, respectively; and
a parameter register including a plurality of parameter groups coupled to the plurality of bus lines and the plurality of bus bar lines, wherein the parameter groups store parameters for different operating modes.

2. The semiconductor device of claim 1, wherein each of the parameter groups comprises:
switching units coupled to the pairs of the bus lines and the bus bar lines, respectively; and
latches coupled to the switching units, respectively, and storing the parameters.

3. The semiconductor device of claim 2, wherein each of the switching units comprises:
a first switch suitable for coupling the bus line and a first node of the latch to each other in response to a first switching signal; and
a second switch suitable for coupling the bus bar line and a second node of the latch in response to a second switching signal.

4. The semiconductor device of claim 1, wherein when a selected parameter group among the parameter groups stores or outputs the parameters, remaining parameter groups do not operate.

5. The semiconductor device of claim 1, further comprising reset circuits coupled to the bus lines or the bus bar lines, respectively, and suitable for resetting the latches.

6. A semiconductor device, comprising:
a memory cell array storing data;
a peripheral circuit performing a program operation, a read operation, and an erase operation on the memory cell array; and
a control circuit storing parameters for different operating modes in different parameter groups, wherein the control circuit is suitable for controlling the peripheral circuit by outputting parameters stored in a parameter group corresponding to a selected operating mode when operating modes are switched, and causing the semiconductor device to operate in the selected operating mode.

7. The semiconductor device of claim 6, wherein each of the parameter groups comprises:
switching units coupled to pairs of bus lines and bus bar lines, respectively; and
latches coupled to the switching units, respectively, and storing the parameters.

8. The semiconductor device of claim 7, wherein each of the switching units comprises:
a first switch suitable for coupling the bus line and a first node of the latch to each other in response to a first switching signal; and
a second switch suitable for coupling the bus bar line and a second node of the latch in response to a second switching signal.

9. The semiconductor device of claim 7, further comprising reset circuits coupled to the bus lines or the bus bar lines, respectively, and suitable for resetting the latches.

10. The semiconductor device of claim 6, wherein the control circuit is suitable for controlling the parameter groups so that when a selected parameter group among the parameter groups stores or outputs the parameters, remaining parameter groups do not operate.

11. A memory system comprising:
a host suitable for outputting a command signal and addresses; and
a semiconductor device including a control circuit, a peripheral circuit and a memory cell array to perform program, read, and erase operations and exchange data with the host in response to the command signal and the addresses,
wherein the control circuit stores parameters for different operating modes in different parameter groups and is suitable for controlling the peripheral circuit by outputting parameters stored in a parameter group corresponding to a selected operating mode when operating modes are switched, and causing the semiconductor device to operate in the selected operating mode.

12. The memory system of claim 11, wherein each of the parameter groups comprises:
switching units coupled to groups of bus lines and bus bar lines, respectively; and
latches coupled to the switching units, respectively, and storing the parameters.

13. The memory system of claim 12, wherein each of the switching units comprises:
a first switch suitable for coupling the bus line and a first node of the latch to each other in response to a first switching signal; and
a second switch suitable for coupling the bus bar line and a second node of the latch to each other in response to a second switching signal.

14. The memory system of claim 12, further comprising reset circuits coupled to the bus lines or the bus bar lines, respectively, and suitable for resetting the latches.

15. The memory system of claim 11, wherein the control circuit is suitable for controlling the parameter groups so that when a selected parameter group among the parameter groups stores or outputs the parameters, remaining parameter groups do not operate.
